(19) United States
(12) Patent Application Publication
(10) Pub. No.: US 2007/0275316 A1
(43) Pub. Date: Nov. 29, 2007

(54) ELECTROSTATIC IMAGE DEVELOPING TONER

(75) Inventors: Michiaki ISHIKAWA, Kanagawa (JP); Mikihiko SUKENO, Tokyo (JP); Masahiro ANNO, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 11/753,635

(22) Filed: May 25, 2007

(30) Foreign Application Priority Data
May 29, 2006 (JP) JP2006-147795
May 30, 2006 (JP) JP2006-149484

(51) Int. Cl. G03G 9/08

(52) U.S. Cl. 430/108.3

(57) ABSTRACT

An electrostatic image developing toner is disclosed. The toner contains an external additive, which contains inorganic minute particles having a number average primary particle diameter of 5-30 nm and a titanic acid compound treated by silicone oil or a coupling agent.

### FIELD OF THE INVENTION

The present invention relates to an electrostatic image developing toner.

### BACKGROUND OF THE INVENTION

In recent years, the image forming technology of copiers, printer, and facsimile machines has been markedly improved. Of these, the one, which is most frequently employed, relates to an image forming method utilizing electrostatic images represented by an electrophotographic system.

The reasons are that the above imaging method enables formation of high quality images at a high rate, enables formation of not only monochromatic images but also color images, and further exhibits durability and stability for the use over a long period.

However, the demanded level of quality has gradually been elevated. Consequently, it has been sought to enhance the level which has been thought sufficient. Specifically, enhancement of image quality is increasingly demanded, and to meet those requirements, the tendency of reduction of the diameter of toner particles has been pronounced.

It has become difficult to provide toner particles of decreased diameter carrying a sufficient charge amount, for which the following reasons may be cited. As the total surface area increases due to smaller toner particles, the van der Waals force increases, whereby sufficient friction is not achieved with a static charge providing member. Consequently, as smaller diameter toner particles are employed, problems such as toner scattering and fogging tends to occur. Further, even though it is expected to result in enhancement of resolution due to the small particle diameter, cases frequently occur in which the resolution is not as enhanced as expected.

An example of the means, which overcome the above problems, is that as described in JP-A No. 2001-290302, the charge amount distribution of toner particles is narrowed by the addition of titanic acid compounds, whereby resolution and durability are improved.

However, developers have been subjected to stronger stress due to elevation of temperature in machines due to down-sizing and pressing pressure to the developer amount regulating section, accompanied with an increase in the rate, those which are increasingly performed in recent years. In such situations, further image problems occur such as toner scattering and fogging, as well as degradation of resolution. Specifically, in polymerization toner, since the polar group on the surface of toner particles is oriented, resulting in ease of water absorption, the above problems are more pronounced during output of images particularly under high temperature and high humidity.

U.S. Pat. No. 6,335,135 discloses a toner containing an external additive comprising strontium titanate particles having a number average particle size of 80 to 800 nm.

### SUMMARY OF THE INVENTION

In view of the foregoing, the present invention was achieved. An object of the present invention is to provide an electrostatic image developing toner which exhibits excellent developability and excellent reproduction of fine lines and enables stable formation of high quality images over a long period.

### MEANS TO DISSOLVE THE PROBLEM

The problem mentioned above of the present invention is dissolved by the following invention.

1. An electrostatic image developing toner comprising a toner particle containing at least a resin and a colorant and an external additive wherein the additive contains inorganic minute particles having a number average primary particle diameter of 5-30 nm and a titanic acid compound treated by silicone oil or a coupling agent.

### 2. The electrostatic image developing toner of claim 1 wherein an acid value of the toner particle is 5-30 KOH mg/g.

### 3. The electrostatic image developing toner of claim 1 wherein a number average primary particle diameter of the titanic acid compound is 100-2,000 nm.

### 4. The electrostatic image developing toner of claim 1 wherein an added amount of the titanic acid compound is 0.1-10.0 weight percent based on toner particles.

### ADVANTAGE CF THE INVENTION

According to the present invention, it is possible to provide an electrostatic image developing toner which exhibits excellent developability and excellent reproduction of fine lines, and also enables stable formation of high quality images over a long period.

In view of the above problems, the inventors of the present invention conducted investigations of carriers, development sleeves, and toner particles which tend to stain a static charge providing member. As a result, it was discovered that by simultaneously employing, as external additives, diameter specified minute inorganic particles and titanic acid compounds treated with silicone oil or with coupling agents, stability of charging property was secured, whereby the object of the present invention was achieved. Thus, the present invention was accomplished.

The present invention will now be detailed.

### (Titanic Acid Compounds)

In one embodiment of the present invention the toner contains the external additives contains a titanic acid compound which are treated with silicone oil or coupling agents.

The reason why the static charge stabilization effects of the titanic acid compounds are pronounced is not clear. However, the reason is assumed to be that the titanic acid compounds exhibit a high dielectric constant. It is assumed that by employing high dielectric titanic acid compounds, the charge providing capability of small-diameter toner particles is enhanced, resulting in stabilization of charging property. Examples of titanic acid compounds include barium titanate, calcium titanate, magnesium titanate and strontium titanate.

The particle diameter of titanic acid compounds is commonly 100-2,000 nm in terms of the number average diameter of the primary particles, but is preferably 200-1,000 nm. When the particle diameter is below the above lower limit, static charge providing capability is lowered resulting in a decreased tendency to contribute to stabilization of charging property. On the other hand, when the particle diameter exceeds the upper limit, titanic acid compounds tend to be released from the toner particles, resulting in an increase in adhesion onto the photoreceptor, whereby problems may occur in which abrasion on the photoreceptor tends to result.

The particle diameter of titanic acid compounds is not substantially changed via treatment by silicone oil or a coupling agent.

The titanic acid compounds contain the silicone oil or a coupling agent at least a part of the surface of the titanic acid compounds due to treatment by silicone oil or a coupling agent.

The added amount of titanic acid compounds is commonly 0.1-10.0% by weight based on the total weight of the toner particles, is preferably 0.3-5.0% by weight, but is more preferably 0.4-2.0% by weight. When the added amount is less than the lower limit, effects such as charging stabilization may occasionally not be realized. On the other hand, when the added amount exceeds the upper limit, titanic acid compounds are released from toner particles, occasionally resulting in problems such abrasion of the photoreceptor.

Further, as the image forming process was repeated, non-uniformly shape toner particles as well as toner particles exhibiting corners tended to result in staining. The reason for the above is not clear, but one reason is assumed to be as follows. Non-uniformly shaped toner particles tend to be subjected to mechanical stress such as agitation in the development apparatus, resulting in formation of portions to which excessive stress is applied, whereby toner components are transferred and adhered to materials to be stained, and charging property of the toner particles is changed.

Further, application of the above stress differs depending on the diameter of toner particles. Toner particles of a less diameter exhibit greater adhesion force. Due to that, they tend to result in staining when subjected to stress. Toner particles of a relatively large diameter tend to not result in the above staining, but problems occur in which image quality such as resolution is degraded.

Further, the charge amount distribution of the initial electrostatic image developing toner (hereinafter also referred simply to as “toner”) plays an important role in the above staining. When the charge amount distribution is broad, the following problems occur. An incomplete development phenomenon occurs during the image forming process, and toner particles which are not readily employed for development accumulate in the development device, resulting in degradation of developability. Accumulated toner particles are subjected to stress over a long period of time to result in staining. Further, the surface of toner particles is modified to change the charging property, whereby toner particles are weakly charged or exhibit reverse polarity, resulting in deteriorated image quality.

The above charge amount distribution of toner particles was investigated. As a result, it was discovered that in order to extremely narrow the charge amount distribution, it was essential to reduce fluctuation in the diameter of toner particles and simultaneously to reduce fluctuation in their shape. By narrowing the charge amount distribution of toner particles, it was possible to realize stable charging property over a long period even when the charging amount of toner particles was lowered.

Employed as a toner, which realizes the above features, may be a polymerization toner. On the other hand, since in a polymerization toner, polar groups tend to become oriented on the surface of the toner particles, based on the production method, ambient moisture is adsorbed on the surface of toner particles, resulting in a decrease in charge generating capability and charge holding capability of the particle surface, especially under high temperature and high humidity, whereby the above drawbacks have not been sufficiently overcome.

It is possible to produce stable images by applying, to such a toner, titanic acid compounds treated with silicone oil or coupling agents described in the present invention.

In such a case, the acid value as a toner is controlled to preferably 5-30 KOH mg/g. When the acid value is at least 30 KOH mg/g, image problems such as toner scattering and fogging are apt to occur due to a decrease in charging capability under high temperature and high humidity.

On the contrary, when the acid value is at most 5 KOH mg/g, image problems such as decrease in density or halftone slight touching are apt to occur under low temperature and low humidity.

The reason of this large charging stabilization effect of titanic acid compounds is not clear. However, one reason is assumed to be that they are high dielectrics. By employing titanic acid compounds which are high dielectrics, the charging property providing capability of small diameter toner particles is enhanced, whereby it is possible to realize stabilization of the charging property.

### <Silicone Oil>

Silicone oil employed for the treatment of the titanic acid compound includes;

a dimethyl polysiloxane compound represented by the formula (1),

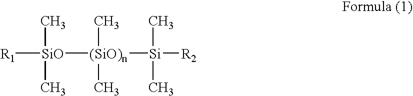

(in the formula, R₁ and R₂ represent CH₃ or OH, n is a number of recurring units and represents an integer of 1 or more),

a methyl hydrogen polysiloxane compound represented by the formula (2),

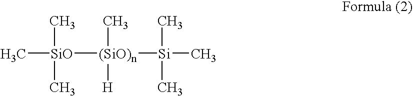

(in the formula, n is a number of recurring units and represents an integer of 1 or more),

a methyl phenyl polysiloxane compound represented by the formula (3),

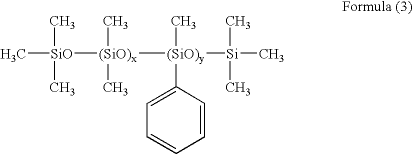

(in the formula, x and y are each a number of recurring units and represents an integer of 1 or more),

a silicone oil having an organo group which has at least one of nitrogen atoms in the side chain, represented by the formula (4) and (5),

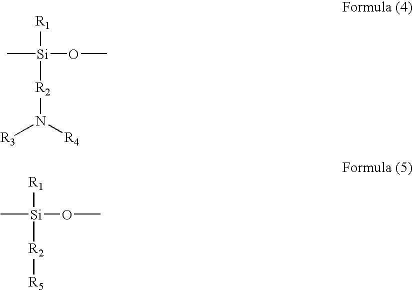

(in the formula, R₁ represents a hydrogen atom, an alkyl, aryl or alkoxy group, R₂ represents an alkylene or phenylene group, R₃ and R₄ represent a hydrogen atom, an alkyl or aryl group, R₄ represents a nitrogen containing heterocyclic ring. The alkyl, aryl, alkylene or phenylene group may have an organo group containing a nitrogen atom, or may have a substituent such as halogen as far as it does not deteriorate chargeability.)

The silicone oil may be subjected to modification such as alkyl-modification, amino-modification, epoxy polyether modification, carboxy-modification, mercapto-modification, alcohol-modification, and fluorine-modification if necessary.

The silicone oil treatment of titanic acid compound can be conducted adding it to the titanic acid compound during it is dispersed mechanically by a wet or dry method, whereby a primary particle diameter can be adjusted.

The amount to be added is preferably 0.05-5.0% by weight, more preferably, 0.5-2.0% by weight to titanic acid compound. The effect for image stability under state of high temperature and high moisture is not sufficient enough when it is not more than 0.5% by weight, and a problem lowering the chargeability is apt to be caused by releasing of excess component when it is more than 5.0% by weight.

### <Coupling Agents>

Coupling agents which are employed for coupling agent treatment of titanic acid compounds may include alkylalkoxysilanes such as methyltrialkoxysilane, methyltriethoxysilane, ethyltriethoxysilane, hexyltrimethoxysilane, or octyltrimethoxysilane.

Further, coupling agents, represented by following Formula (1), may be employed.

CₙH₂ₙ₊₁—Si—(OCₘH₂ₘ₊₁)₃ Formula (1)

Wherein n represents an integer of 4-12, m represent an integer of 1-3, while n is preferably an integer of 6-10 and m is preferably 1 or 2. When n in Formula (1) is at most 4, the treatment progresses easily, but hydrophobicity is not sufficiently realized. On the other hand, when n is at least 13, hydrophobicity is sufficiently realized but fluidity providing capability is degraded due to an increase in coalescence of titanium oxide particles, whereby the fluidity providing capability is lowered. Further, when m is more than 3, reactivity is lowered resulting in insufficient realization of hydrophobicity.

A common dry-system hydrophobizing treatment method may be employed as a method to treat the surface of titanic acid compounds with coupling agents.

For example, in the presence of acids or bases or under the conditions in which the temperature is higher than the boiling point of a base, while vigorously stirring titanic acid compounds, coupling agents themselves, or which are diluted with appropriate solvents, are dripped at a constant rate. In this case, coupling agents are previously blended with acids or bases, and the resulting mixture may simultaneously be added. After dripping, stirring is continued for a while upon maintaining the temperature, whereby the coupling treatment is completed. Other than the above method, there is a method in which a coupling treatment is carried out in such a manner that titanic acid compounds, coupling agents, acids or bases, and water vapor are individually conveyed into a fluidized-bed reaction vessel, employing inert gases.

The added amount of coupling agents incorporated on the surface of titanic acid compounds is preferably 0.01-10 parts by weight based on the total weight of the total weight of titanic acid compounds, and is more preferably 0.5-5 parts by weight. When the amount of the coupling agents is less than 0.01 part by weight, effects to stabilize image quality under high temperature and high humidity are not sufficiently realized, while when it exceeds 10% by weight, problems occur in which the resulting charging property is degraded due to formation of free coupling agents.

### (Minute Inorganic Particles)

One of the features of the present invention is that minute inorganic particles at a number average diameter of the primary particles of 5-30 nm are incorporated as an external additive, further to the titanic acid compound treated by silicone oil or a coupling agent.

Preferred examples of minute inorganic particles include silica, alumina, and titanium oxide. Further, it is preferable that these minute inorganic particles undergo hydrophobic treatment employing silane coupling agents or titanium coupling agents. The minute inorganic particles are added in an amount of 0.1 to 5% by weight based on the toner particles.

The number average diameter of primary particles of the above minute inorganic particles is 5-30 nm. The particle diameter can be determined employing a transmission type electron microscope or a field-effect scanning type electron microscope.

### (Resins)

Resins to structure the toner according to the present invention include one which is produced via an addition polymerization reaction such as radical polymerization, and another which is produced by polymerization addition or condensation polymerization reaction. However, in the present invention preferred are those which are produced by addition polymerization such as radical polymerization.

### (Resins Produced by Addition Polymerization Such as Radical Polymerization)

A polymerization toner is produced employing resins produced by addition polymerization such as radical polymerization. As noted above, in the polymerization toner, due to its production method, polar groups tend to be oriented on the surface of toner particles. Consequently, specifically at high temperature and high humidity, problems have occurred in which charge generating capability and charge maintaining capability on the surface of toner particles tend to be degraded due to adsorption of ambient moisture onto the surface of toner particles. However, the above problems are solved by employing titanic acid compounds treated with silicone oil or coupling agents, described in the present invention. By utilizing features of the polymerization toner in which fluctuation of the particle diameter and shape of toner particles can be controlled within a small range, and the charge amount distribution of the toner particles can be narrowed, even when the charge amount of the toner is set to be relatively low, it is possible to realize stable charging property over a long period of time, and to also produce stable images.

Polymerization toner, as described herein, refers to a toner which is produced in such a manner that preparation of binder resins for the toner and the shape formation of toner particles are carried out via polymerization of monomers as a raw material of binder resins and if necessary, via the following chemical treatment. More specifically, the polymerization toner refers to a toner which is produced via polymerization reaction such as suspension polymerization or emulsion polymerization and if necessary, via a fusion process among the particles after the above reaction.

Production methods of suspension polymerization toner and emulsion polymerization toner, which enable production of spherical toner particles, are disclosed in JP-A Nos. 2000-214629 and 2003-84480.

Material, preparation method and so on for polymerization toner are described below.

A radical polymerization monomer is employed as a constituting component for the polymerization monomer for the polymerization method, and a cross linking agent can be employed if necessary. It is preferable to incorporate at least one kind of a radical polymerization monomer having an acid group or a radical polymerization monomer having a base group.

(1) Radical Polymerization Monomer

Known monomers can be employed for the hydrophobic monomer constituting the monomer composition without limitation particularly. One or a combination of two or more kinds of the monomer may be employed to satisfy required properties.

In concrete, aromatic vinyl monomer, methacrylate or acrylate monomer, vinyl ester monomer, vinyl ether monomer, mono-olefin monomer, di-olefin monomer and halogenized olefin monomer are included.

Examples of the vinyl aromatic monomer include a styrene monomer such as styrene, o-methyl styrene, m-methyl styrene, p-methyl styrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n dodecylstyrene, 2,4-dimethylstyrene and 3,4-dichlorostyrene, and a derivative thereof.

Examples of the acrylate and methacrylate monomer include methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexyl methacrylate, ethyl β-hydroxyacrylate, propyl γ-aminoacrylate, stearyl methacrylate, dimethylaminoethyl methacrylate and diethylaminoethyl methacrylate.

Examples of the vinyl ester monomer include vinyl acetate, vinyl propionate and vinyl benzoate.

Examples of the vinyl ether monomer include vinyl methyl ether, vinyl ethyl ether, vinyl isobutyl ether and vinyl phenyl ether, Examples of the mono-olefin monomer include ethylene, propylene, iso-butylene, 1-butene, 1-pentene and 4-methyl-1-pentene.

Examples of the di-olefin monomer include butadiene, isoprene and chloroprene.

Examples of the halogenated-olefin monomer include vinyl chloride, vinylidene chloride, and vinyl bromide.

(2) Crosslinkable Monomer

A crosslinkable monomer may be added for improving the toner characteristics. As the crosslinking agent, ones having two or more unsaturated bonds such as divinylbenzene, divinylnaphthalene, divinyl ether, diethylene glycol methacrylate, ethylene glycol dimethacrylate, polyethylene glycol dimethacrylate and diallyl phthalate are included.

(3) Monomers Having an Acidic Group or a Base Group

As a monomer having an acidic group or a base group a polymerizable monomer having a carboxylic group and a sulfonic acid group, and an amino polymerizable monomer such as a primary, secondary tertiary, and quaternary amine ammonium salt can be exemplified.

Examples of the compound having a carboxylic group include acrylic acid, methacrylic acid, fumaric acid, maleic acid, itaconic acid, cinnamic acid, butyl mono-maleate, and octyl mono-maleate.

Examples of the compound having a sulfonic acid group include styrene sulfonic acid allylsuofosuccinic acid, octyl allylsulfosuccinate.

These may be a salt of alkali metal such as sodium and potassium, or a salt of alkali earth metal such as calcium.

Listed as radically polymerizable monomers having a basic group are amine based compounds which include dimethylaminoethyl acrylate, dimethylaminoethyl methacrylate, dimethylaminoethyl acrylate, and dimethylaminoethyl methacrylate, as well as quaternary ammonium salts of the above four compounds, 3-dimethylaminophenyl acrylate, 2-hydroxy-3-methacryloxypropyltrimethyl ammonium salt, acrylamide, N-butylacrylamide, N,N-dibutylacrylamide, piperidylacrylamide, methacrylamide, N-butylmethacrylamide, N-octadecylacrylamide; vinylpyridine, and vinylpyrrolidone; vinyl-N-methylpyridinium chloride, vinyl-N-ethylpyridinium chloride, N,N-diallylmethylammonium chloride, N,N-diallylethylammonium chloride.

The used amount of radically polymerizable monomers having an acidic group or a basic group, employed in the present invention, is preferably 0.1-15% by weight based on the total weight of the radically polymerizable monomers. The used amount of radically polymerizable crosslinking agents, though varied depending on their characteristics, is preferably in the range of 0.1-10% by weight based on the total weight of the radically polymerizable monomers.

(4) Chain Transfer Agents

To regulate molecular weight, it is possible to employ commonly used chain transfer agents. Chain transfer agents are not particularly limited, and examples of usable ones include octylmercaptan, dodecylmercaptan, tert-dodecylmercaptan, n-octyl-3-mercaptopropionate, carbon tetrabromide, and styrene dimers.

(5) Polymerization Initiators

In the present invention, it is possible to employ appropriate radical polymerization initiators as long as they are water-soluble. Examples include persulfates (potassium persulfate and ammonium persulfate), azo based compounds (4,4′-azobis-cyanovaleric acid and salts thereof, and 2,2′-azobis(2-amidinopropane) salts), and peroxide compounds.

The above polymerization initiators may be used as a redox type initiator by combining with a reducing agent, according necessity. By the use of the redox initiator, the activity of polymerization is raised so as the temperature for the polymerization can be lowered and the shortening of the polymerization time can be expected.

For example, a temperature of from 50° C. to 90° C. applied for the polymerization, even though any temperature can be applied as long as the temperature is higher than the lowest radical generation temperature. The polymerization can be progressed at a room temperature of near room temperature by the use of a room temperature initiator such as a combination of hydrogen peroxide and a reducing agent such as ascorbic acid.

(6) Surface Active Agents

In order to carry out polymerization employing the above-mentioned radically polymerizable monomers, it is necessary to perform oil-droplet dispersion in an aqueous medium employing surface active agents. Surface active agents, which are usable during the above dispersion, are not particularly limited. It is possible to list the ionic surface active agents listed below as appropriate examples.

Ionic surface active agents include sulfonates (sodium dodecylbenzenesulfonate, sodium aryl alkyl polyether sulfonate, sodium 3,3-disulfonediphenylurea-4,4-diazo-amino-8-naphthol-6-sulfonate, ortho-carboxybenzene-azo-dimethylaniline, and sodium 2,2,5,5-tetramethyl-triphenylmathane-4,4-diazo-bis-β-napthol-6-sulfonate), sulfuric acid ester salts (sodium dodecylsulfate, sodium tetradecyl sulfate, sodium pentadecyl sulfate, and sodium octyl sulfate), and fatty acid salts (sodium oleate, sodium laurate, sodium caprate, sodium caprylate, sodium caproate, potassium stearate, and calcium oleate).

Further, nonionic surface active agents may be employed. Specifically listed are polyethylene oxide, polypropylene oxide, a combination of polypropylene oxide and polyethylene oxide, esters of polyethylene glycol and higher fatty acids, alkylphenol polyethylene oxide, esters of fatty acids and polyethylene glycol, esters of fatty acids and polypropylene oxide, and sorbitan ester.

In the present invention, these are employed as an emulsifier during emulsion polymerization, but may be employed in other processes or for other purposes.

### (Resins Prepared Via Polyaddition or Polycondensation reaction)

Other types of resins which constitute the toner of the present invention are prepared via polyaddition or polycondensation reaction. In the present invention, these resins are preferably incorporated in an amount of at least 30% by weight.

Polycondensation reaction, as described herein, refers to the reaction in which a compound having a plurality of functional groups undergoes condensation reaction one after other while releasing low molecular weight compounds such as water or alcohol to form polymers. Examples of well known polycondensation reaction include a reaction in which polyamide (being 66 nylon) is prepared in such a manner that hexamethylenediamine and adipic acid undergo reaction upon releasing water, and a reaction in which polyester (being polyethylene terephthalate) is prepared employing ethylene glycol and terephthalic acid ester, being accompanied with elimination.

On the other hand, polyaddition reaction, as described herein, refers to a reaction in which a new bond is formed via addition reaction between functional groups of a compound having a functional group, and the above reaction is sequentially repeated to form a polymer. Thus, a polymer is formed without releasing low molecular weight compounds, differing from the polycondensation reaction.

Further, as noted above, polyaddition reaction is different from polyaddition reaction such as radical polymerization since reaction between functional groups is sequentially repeated. An example of the well-known polyaddition reaction includes a reaction in which polyurethane is prepared employing hexamethylene diisocyanate and tetramethylene glycol.

Any resins, which are prepared via polyaddition or polycondensation reaction, may be employed in the present invention as long as they form resin particle dispersion in an aqueous medium. Representative examples include amorphous polyester resins and polyol resins; however, the amorphous polyester resins are more preferred.

### <Amorphous Polyester Resins>

Exemplified as dihydric alcohol monomers to prepare amorphous polyester resins may be etherized bisphenols such as polyoxypropylene(2,2)-2,2-bis(4-hydroxyphenyl)propane, polyoxypropylene(3,3)-2,2-bis(4-hydroxyphenyl)propane, polyoxyethylene(2.0)-bis(4-hydroxyphenyl)propane, polyoxypropylene(2.0)-polyoxyethylene(2.0)-2,2-bis(4-hydroxyphenyl)propane, or polyoxypropylene(6)-2,2-bis(4-hydroxyphenyl)propane, as well as ethylene glycol, diethylene glycol, triethylene glycol, 1,2-propylene glycol, 1,3-propylene glycol, 1,4-butanediol, 1,4-butenediol, neopentyl glycol, 1,5-pentanediol, 1,6-hexanediol, 1,4-cycloheane dimethanol, dipropylene glycol, polyethylene glycol, polypropylene glycol, polytetramethylene glycol, bisphenol A, and hydrogenated bisphenol A.

Exemplified as dihydric carboxylic acid monomers may be maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecylsuccinic acid, n-dodecenylsuccinic acid, isododecylsuccinic acid, isododecenylsuccinic acid, n-octylsuccinic acid, and n-octenylsuccinic acid, as well as anhydrides or lower alkyl esters thereof.

In the present invention, it is possible to employ polyhydric alcohol monomers and polyhydric carboxylic acid monomers.

Exemplified as trihydric or polyhydric alcohol monomers may be sorbitol, 1,2,3,6-hexanetetraol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butasnetriol, trimethylolethane, trimethylolpropane, and 1,3,5-trihydroxymethylbenzene.

Exemplified as trihydric and polyhydric carboxylic acid monomers may be 1,2,4-benzenetricarboxylic acid, 2,5,7-naphthalenetricarboxylic acid, 1,2,4-naphthalenetricarboxylic acid, 1,2,4-butnaetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, and empol trimer acid, as well as anhydrides or lower alkyl esters thereof.

To improve stability of toner charging characteristics against ambience via sealing the polar group of the polyester polymer terminals, monofunctional monomers are occasionally introduced into polyester.

Employed as monofunctional monomers may be monocarboxylic acids and lower alkyl esters thereof such as benzoic acid, chlorobenzoic acid, bromobenzoic acid, parahydroxybenzoic acid, sulfobenzoic acid monoammonium salt, sulfobenzoic acid monosodium salt, cyclohexylaminocarbonylbenzoic acid, n-dodecyaminocarbonylbenzoic acid, tertiary butylbenzoic acid, naphthalenecarboxylic acid, 4-methylbenzoic acid, 3-methylbenzoic acid, salicylic acid, thiosalicylic acid, phenylacetic acid, acetic acid, propionic acid, butyric acid, isobutyric acid, octanecarboxylic acid, lauric acid, or stearic acid, as well as monoalcohols such as aliphatic alcohol, aromatic alcohol, or alicyclic alcohol.

Further, the polyester resins employed in the present invention may be modified to incorporate a urethane bond in the molecular structure called urethane modified polyester.

### <Polyol Resin>

Various types of resin may be utilized as polyol resin, however, the following are specifically preferred in this invention.

Preferably utilized are polyols prepared by reacting epoxy resin, an alkyleneoxide adduct of dihydric phenol or glycidyl ether thereof, with a compound having at least two reactive hydrogen atoms which react with an epoxy group in the molecule. Further, specifically preferable epoxy resins are at least two types of bisphenol A type epoxy resins having different number average molecular weights. These polyols are effective for providing excellent glossiness and transparency as well as resistance to offset.

Epoxy resins utilized in this invention are preferably those prepared by combining bisphenols such as bisphenol A and bisphenol F with epichlorohydrin. Epoxy resin is preferably comprised of at least two types of bisphenol A type epoxy resins having different number average molecular weights; the number average molecular weight of the lower molecular weight component being 360-2,000 and the number average molecular weight of the higher molecular weight component being 3,000-10,000 which achieve stable fixing characteristics and glossiness. Further, the lower molecular weight component is preferably contained in the range of 20-50 weight %, and the higher molecular weight component is preferably contained in the range of 5-40 weight %.

A toner image having adequate glossiness property as well as good fixing ability is obtained and toner having stable store ability is obtained by utilizing bisphenol A type epoxy resin having the lower molecular weight component and the higher molecular weight component mentioned above.

As compounds utilized in this invention, that is, as alkyleneoxide adducts of dihydric phenols, listed are the following. Listed are reaction products of ethyleneoxide, propyleneoxide, butyleneoxide and mixtures thereof, with bisphenols such as bisphenol A and bisphenol F. The prepared adducts may be glycidylized by use of epichilorohydrin or β-methyl epichlorohydrin. Specifically, preferred are diglycidyl ether of alkyleneoxide adducts of bisphenol A, represented by following general formula (6).

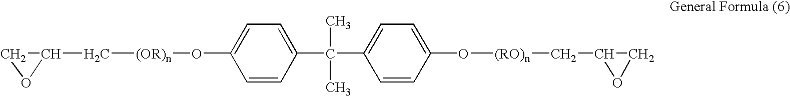

(wherein, R is

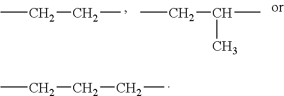

In the formula, n and m are numbers of a recurring unit and being at least 1, and “n+m” is from 2 to 6.)

Further, an alkyleneoxide adduct of dihydric phenol or glycidyl ether thereof is preferably contained at 10-40 weight % based on polyol resin.

It is observed that a toner image having good glossiness property as well as good fixing ability is obtained and toner having store ability is stabilized when numbers of recurring unit m and n has the relation mentioned above.

Compounds having one reactive hydrogen atom which reacts with an epoxy group in the molecule are a monohydric phenol compound, a secondary amine compound and a carboxylic acid compound.

As a monohydric phenol compound, exemplified are the following. Listed are such as phenol, cresol, isopropylphenol, aminophenol, nonylphenol, dodecylphenol, xylenol and p-cumylphenol. As a secondary amine compound, listed are diethylamine, dipropylamine, dibutylamine, N-methyl(ethyl)piperazine and piperidine. Further, as carboxylic acid compound, listed are propionic acid and caproic acid.

Various combinations of raw materials are possible to prepare polyol resin of this invention provided with an epoxy resin portion and an alkyleneoxide portion in the main chain. For example, it can be prepared by reacting epoxy resin having glycidyl groups on both ends and an alkyleneoxide adduct of a dihydric phenol having glycidyl groups on both ends with dihalide diisocyanate, diamine diol polyhydric phenol or dicarboxylic acid. Among them with respect to reaction stability preferred is to react a dihydric phenol.

Further, it is also preferable to utilize a polyphenol series and a polybasic carboxylic acid series together with dihydric phenol. Herein, the amount of a polyhydric phenol compound or a polybasic carboxylic acid compound is generally at most 15% but preferably at most 10% based on the total amount.

A compound provided with two or more reactive hydrogen atoms which react with an epoxy group in the molecule includes a dihydric phenol series, a polyhydric phenol compound, and a polybasic carboxylic acid compound. As dihydric phenol compound, listed are bisphenols such as bisphenol A and bisphenol F. As a polyhydric phenol compound, exemplified are an orthocresol novolak compound, a phenol novolak compound, tris(4-hydroxyphenyl)methane and 1-[α-methyl-α-(4-hydroxyphenyl)ethyl]benzene. As a polybasic carboxylic acid compound, exemplified are malonic acid, succinic acid, glutaric acid, adipic acid, maleic acid, fumaric acid, phthalic acid, terephthalic acid, trimellitic acid and trimellitic acid anhydride. Further, these polyester resins or polyol resins preferably provided with no cross-linking or at least weak cross-linking (being at most 5% of the THF insoluble portion), because transparency or glossiness are barely obtained when it is provided with a high cross-linking density.

It is preferable that the polyol resin is used in combination with a polyester resin because the adjustment of acid value is not easy.

### <Colorant>

The colorant used in the toner according to the present invention is described.

Examples of the black pigment to be employed for preparation of the toner are carbon black such as furnace black, channel black, acetylene black, thermal black and lump black, and a magnetic powder such as magnetite and ferrite.

The inorganic pigment can be employed singly or in a combination of plural kinds thereof. The content of the inorganic pigment is preferably from 2% to 20% by weight, and more preferably from 3% to 15% by weight.

When the toner is employed as a magnetic toner, the magnetite can be added. In such the case, the content of it in the toner is preferably from 20% to 120% by weight for providing desired magnetic properties.

Know organic pigments and dyes are also usable. Concrete examples of the organic pigment and dye are listed below.

Examples of the magenta of red organic pigments for preparation of the magenta toner include C. I. Pigment Red 2, C. I. Pigment Red 3, C. I. Pigment Red 5, C. I Pigment Red 6, C. I. Pigment Red 7, C. I. Pigment Red 15, C. I. Pigment Red 16, C. I. Pigment Red 48:1, C. I. Pigment Red 53:1, C. I. Pigment Red 57:1, C. I. Pigment Red 122, C. I. Pigment Red 123, C. I. Pigment Red 139, C. I. Pigment Red 144, C. I. Pigment Red 149, C. I. Pigment Red 166, C. I. Pigment Red 177, C. I. Pigment Red 178 and C. I. Pigment Red 222.

Examples of orange or yellow pigment for preparation of the yellow toner include C. I. Pigment orange 31, C. I. Pigment Orange 43, C. I. Pigment Yellow 12, C. I. Pigment Yellow 13, C. I. Pigment Yellow 14, C. I. Pigment Yellow 15, C. I. Pigment Yellow 17, C. I. Pigment Yellow 93, C. I. Pigment Yellow 94, C. I. Pigment Yellow 138, C. I. Pigment Yellow 180, C. I. Pigment Yellow 185, C. I. Pigment Yellow 155 and C. I. Pigment Yellow 156.

Examples of green or cyan pigment for preparation of the cyan toner include C. I. Pigment Blue 15, C. I. Pigment Blue 15:2, C. I. Pigment Blue 15:3, C. I. Pigment Blue 16, C. I. Pigment Blue 60 and C. I. Pigment Green 7.

Examples of dye include C. I. Solvent Red 1, 49, 52, 58, 63, 111 and 122, C. I. Solvent Yellow 19, 44, 77, 79, 81, 82, 93, 98, 103, 104, 112 and 162, and Solvent Blue 25, 36, 60, 70, 93, and 95. These dyes can be employed singly or in combination of plural kinds thereof.

The usable amount is preferably from 1% to 20% by weight, based on the 100% of resin.

### (Waxes (Releasing Agents))

In the present invention, in order to provide appropriate releasing properties with a developer, it is preferable to incorporate waxes in toner. The melting point of waxes is preferably 40-120° C., but is most preferably 50-110° C.

By setting the melting point as mentioned above range, it has been confirmed that even though fixing temperature is set to be relatively low, desired fixability is realized and desired offset resistance and durability are also realized.

Melting point of waxes can be determined via differential scanning calorimetry (DSC). Namely, a several mg sample is heated at a constant temperature elevation rate such as 10° C./minute, and the resulting melting peak value is designated as the melting point.

Examples of releasing agents (waxes) usable in the present invention include solid paraffin wax, micro-wax, rice wax, fatty acid amide based wax, fatty acid based wax, aliphatic monoketones, fatty acid metal salt based wax, fatty acid ester based wax, partially saponified fatty acid ester based wax, higher alcohols, and carnauba wax.

Further, it is possible to employ polyolefin such as low molecular weight polyethylene or polypropylene. Specifically preferred is polyolefin at a softening point of 70-150° C. which is determined via the ring and ball method, but more preferred is polyolefin at a softening point of 120-150° C.

Further listed are ester compounds represented by following Formula (7).

R₁—(OCO—R₂)ₙ Formula (7)

wherein R₁ and R₂ each represent a hydrocarbon group having 1-40 carbon atoms, which may have a substituent, and n represents an integer of 1-4.

Further, in the present invention, toner particles may be formed employing a dispersion which is prepared in such a manner that wax is heated and stirred in the presence of surface active agents and dispersing agents. In this case, for example, a wax emulsion, which is prepared by emulsifying wax, is produced. When resin particles are aggregated, it is possible to add the wax emulsion while aggregated together with a colorant dispersion.

In the present invention, in order to minimize release of wax particles from toner particles, preferably employed are ester, wax, amide wax, carnauba wax and rice wax. Further, polyolefin wax, which is subjected to acid modification, is preferably employed.

### Charge Control Agent

Toners of this invention may contain a charge control agent. Examples of the charge controlling agent include nigrosine type dyes, triphenylmethane type dyes, chromium-containing metal complex dyes, molybdate chelate pigments, Rhodamine type dyes, alkoxyl amines, quaternary ammonium salts including fluorine-modified quaternary ammonium salts, alkylamides, elemental phosphor and its compounds, elemental tungsten and its compounds, fluorine-containing surfactants, metal salts of salicylic acid and metal salts of salicylic acid derivative. In concrete, nigrosine type dye Bontron 03, quaternary ammonium salt Bontron P-51, azo type metal complex compound Bontron S-34; oxynaphthoic type metal complex E-89, salicylic acid type metal complex E-84, and phenol type condensation product E-89, each produced by Orient Chemical Industries, Ltd.; quaternary ammonium salt molybdenum complex TP-302 and TP-415, each produced by Hodogaya Chemical Co., Ltd.; quaternary ammonium salt Copycharge PYS VP2038, triphenylmethane derivative Copyblue PR, quaternary ammonium salt Copycharge NEGVP2036, and Copycharge NX V434, each produced by Hoechst CO., Ltd.; LRA-901, and boron complex LR-147, each produced by Japan Carlit Co. Ltd.; copper phthalocyanine, perylene, quinacridone, azo type pigments, and polymers having a functional group such as a sulfonic acid group, a carboxyl group and quaternary ammonium salt group. Among them, azo type metal complex compounds are preferred. For example, ones disclosed in paragraphs 0009 to 0012 of JP O.P.I. Publication No. 2002-351150 are preferably used.

The charge controlling agent is preferably used in an ratio of from 0.1 to 10 parts by weight, preferably 0.2-5 parts by weight, to 100 parts by weight of the binder resin even though the amount of the agent cannot be simply decided since the amount is determined depending on the kind of the binder resin, presence of additive to be added according to necessity, and the producing process of the toner including the dispersing method in the invention. Charging property is too high and decreases the effect of the main charge control agent electrostatic attractive force increases and causes deteriorate of fluidity of the toner and image density.

It is preferable to add the charge control agent to near the surface of the inner part of the toner particle in the invention. The charging property can be effectively given to the toner particle and the fluidity of the toner can be maintained by adding the charge control agent to near the surface of the toner particle since the charge control agent is added so that the charge control agent is not exposed to the toner surface.

As the practical method to incorporate the charge controlling agent, for example, a method by which the amount of the charge controlling agent to be added to the resin particle constituting the toner particle. Such the method includes a method by which more amount of the charge controlling agent is added to the resin particle for constituting the near surface of the toner particle and the resin particles are aggregated so that the surface of the toner particle is constituted by resin particles containing no charge controlling agent, and a method by which the resin particles containing are aggregated and then thus prepared aggregated particles are each encapsulated by a resin component containing no charge controlling agent on the surface thereof.

It is preferable to mix the charge control agent with the binder resin and to control the diameter of the dispersed particles as the method for incorporating to the interior of the resin particle. However, the charge control agent may also be added into the aqueous phase so as to be taken into the toner in the aggregating process or the drying process when the charge control agent is dissolved out or released to the aqueous phase side.

### <External Additive>

Polymer type micro-particles, for example, polystyrene, methacryl acid ester, acrylic acid ester copolymers, a polycondensation type such as silicone, benzoguanamine and nylon; as well as polymer particles prepared from thermally curable resin, which are prepared by soap-free emulsion polymerization, suspension polymerization or dispersion polymerization are listed for an external additive to assist fluidity, development ability and charging ability of the obtained toner particles in the invention in addition to the additive contains inorganic minute particles having a number average primary particle diameter of 5-30 nm and a titanic acid compound treated by silicone oil or coupling agent mentioned above.

An agent assisting fluidity can be subjected to a surface treatment to increase hydrophobicity and prevent deterioration of fluid characteristics and charging characteristics even under high humidity. For example, listed as a preferable surface processing agent can be such as a silane coupling agent, a silylizing agent, a silane coupling agent having an alkylfluoride group, an organotitanate type coupling agent, an aluminum type coupling agent, silicone oil and modified silicon oil.

An agent enhancing cleaning characteristics to remove developer remaining on the photoreceptor or the primary transfer medium include a metal salt of aliphatic acid such as stearic acid, for example, zinc stearate, calcium stearate, polymer minute particles prepared by soap free polymerization such as polymethyl methacrylate minute particles, polystyrene minute particles and so on. It is preferable that the polymer particles have comparatively narrow particle size distribution and volume average particle diameter of 0.01 to 1 μm.

### <Preparation Method of Toner>

### (Dispersion Method of Resin Particles in an Aqueous Medium)

Methods for producing dispersion by dispersing resin particles into a water-based medium, which are performed in the present invention, are not particularly limited and include the following methods.

1. The following methods are listed in cases of polyaddition of polyester resins and polyol resins, or condensation based resins:

(a) A method to produce a water-based dispersion of resin particles in such a manner that precursors, i.e., monomers or oligomers, or solvent solutions thereof, are dispersed into a water-based medium in the presence of suitable dispersing agents and then hardened by the addition of hardening agents,

(b) A method in which after dissolving suitable emulsifiers in precursors, i.e., monomers or oligomers, or solvent solutions (preferably in the liquid state, and may be liquidified by heating) thereof, phase inversion emulsification is performed by the addition of water.

2. A method in which in the case of vinyl based resins, resin particles are formed employing a suspension polymerization method, an emulsion polymerization method, a seed polymerization method, and a dispersion polymerization method, or a water-based dispersion of the resulting particles are directly produced.

### 3. A method in which resins previously prepared employing a polymerization reaction (may be any polymerization reaction mode such as addition polymerization, or addition condensation) are dispersed into a water-based medium.

(a) Resins prepared as above are pulverized employing a mechanical rotating system or a jet system pulverizer and resin particles are obtained by classifying resulting particles and thereafter, the resulting minute particle are dispersed into water in the presence of appropriate dispersing agents.

(b) A method in which a resinous solution prepared by dissolving the resins prepared as above is sprayed to form resin particles, and thereafter, the aforesaid resin particles are dispersed into water in the presence of suitable dispersing agents.

(c) A method in which resin particles are deposited by adding poor solvents to a resinous solution, prepared by dissolving the resins prepared as above to solvents, or by cooling a resin solution which has been prepared by dissolving to solvent upon heated, and after obtaining the resin particles by removal of solvents, the resulting resin particles are dispersed into water in the presence of suitable dispersing agents.

(d) A method in which a resin solution, prepared by dissolving the resins prepared as above in solvents is dispersed into a water-based medium in the presence of suitable dispersing agent, and the solvent is then removed by vacuum or heating.

(e) A method in which suitable emulsifiers are dissolved in a resin solution, prepared by dissolving the resins prepared as above in solvent, and thereafter, phase inversion emulsification is performed by the addition of water.

Simultaneously employed as emulsifiers or dispersing agents in the above methods are known surface active agent and water-soluble polymer. Further, simultaneously employed as emulsification and dispersing aids may be solvents and plasticizers. Listed as specific examples are those disclosed in paragraphs 0036-0062 of JP-A 2002-284881.

It is preferable to mix mechanically each raw component homogeneously before the dispersion process. A mixing process is at first necessary, in which toner composition including at least a binding resin, and colorant master batch, and a charge control agent and a releasing agent if necessary, are mixed mechanically. This process may be conducted by employing a usual mixing apparatus by rotating blade in usual condition, and there is no particular restriction.

Resin or other toner raw composition is usually stirred employing an impeller, and heat processing if necessary, and dissolution, or dispersion and emulsion-dispersion are conducted in the water-based media by ball mill, sand mill homogenizer and so on.

An emulsifying apparatus such as Homomixer (manufactured by Tokushu Kika Kogyo Co., Ltd.), Ebara Milder (manufactured by Ebara Corp.), and Clear Mix (M Technique Co.) is employed.

By controlling the amount and ratio of an oil phase formed by dispersing a single component, the rotation frequency during emulsification dispersion, and the time, it is possible to achieve the specified droplet diameter and size distribution. It is preferable that emulsification dispersion is performed so that the droplet diameter reaches ½- 1/100 of its intended size. The weight ratio of the components of each toner to the organic solvents is preferably selected between 1:10 and 1:1, while the weight ratio of the water-based medium to the oil phase into which the solution is dispersed is preferably selected between 10:1 and 1:1. However, ratios beyond these ranges are also acceptable.

Employed as water-based media may be water as well as combinations of water with partially water-compatible or infinitely water-compatible organic solvents, which include alcohols such as methanol or ethanol, ketone compounds such as methyl ethyl ketone, and esters such as ethyl acetate.

Organic solvents which are employed to dissolve or disperse the solid components of each toner are not particularly limited as long as they are insoluble or barely soluble in water or are partially soluble and dissolve the toner. Examples include toluene, xylene, benzene, methyl acetate, ethyl acetate, methyl ethyl ketone, and methyl isobutyl ketone. They may be employed individually or in combinations of at least two types. Particularly preferred are aromatic solvents such as toluene or xylene, and tetrahydrofuran (THF), ether and ester of organic acid other than described above.

Listed as dispersing agents which are employed to emulsify-disperse the oil phase, which is a toner component, to the desired particle diameter in a water-based medium, are anionic surface active agents such as alkylbenzenesulfonates, α-olefinsulfonates, or phosphoric acid esters; and nonionic surface active agents such as fatty acid amide derivatives or polyhydric alcohol derivatives.

Further, it is possible to achieve the desired effects by employing surface active agents having a fluoroalkyl group, even in a very small amount. Listed as preferably employed anionic surface active agents having a fluoroalkyl group are fluoroalkylcaroxylic acids having 2-10 carbon atoms and metal salts thereof, disodium perfluorooctanesulfonylglutamate, sodium 3-[omega-fluoroalkyl (having 6-11 carbon atoms) oxy]-1-alkyl (having 3-4 carbon atoms) sulfonate, sodium 3-[omega-fluoroalkanoyl (having 6-8 carbon atoms)-N-ethylamino]-1-propnaesulfonate, fluoroalkyl (having 11-20 carbon atoms) carboxylic acid and metal salts thereof, perfluoroalkylcarboxylic acid (having 7-13 carbon atoms) and metal salts thereof, perfluoroalkyl (having 4-12 carbon atoms)sulfonic acid and metal salts thereof, perfluorooctanesulfonic acid diethanolamide, N-propyl-N-(2-hydroxyethyl)perfluorooctanesulfonamide, perfluoroalkyl (having 6-10 carbon atoms) sulfonamidopropyltrimethylammonium salts, perfluoroalkyl (having 6-10 carbon atoms)-N-ethylsulfonylglycine salts, and monoperfluoroalkyl (having 6-16 carbon atoms) ethylphosphoric acid esters.

The above compounds can be obtained by trade names of, for example, SURFLON S-111, S-112 and S-113 (manufactured by ASAHI GLASS CO., LTD.), FLPORARD FC-93, FC-95, FC-98, and FC-129 (manufactured by SUMITOMO 3M), UNIDYNE DS-101 and DS-102 (manufactured by DAIKIN INDUSTRIES Ltd.), MEGAFAC F-110, F-120, F-113, F-191, F-812, and F-833 (manufactured by Dainippon Ink and Chemicals, Inc.), EFTOP EF-102, 103, 104, 105, 112, 123A, 123B, 306A, 501, 201, and 204 (manufactured by JEMCO Inc.), and FTERGENT F-100 and F150 (manufactured by Neos Co., Ltd.).

Still further, employed as hardly water-soluble inorganic dispersing agents may be tricalcium phosphate, calcium carbonate, titanium oxide, colloidal silica, and hydroxyapatite.

In order to remove organic solvents from an emulsified dispersion, it is possible to accept a method in which organic solvents in liquid droplets are completely removed via evaporation by gradually heating the entire system. It is preferable that the operation is performed under reduced pressure because it is possible to lower the heating temperature. Lowering the heating temperature prevents toner components such as waxes or other components from being dissolved in organic solvents, whereby abnormal aggregation, coalescence, and unification of the emulsified dispersion is minimized. The organic solvent removing process may be performed prior to or after the aggregation process. Removal of organic solvents prior to the aggregation process enables enhancement of fusion and unification among minute particles after aggregation.

Listed as another processing method of those dissolved in organic solvents is a method in which an emulsified dispersion is sprayed into a dry ambience and water-insoluble organic solvents in liquid droplets are completely removed, whereby minute toner particles are formed, and water-based dispersing agents are removed by evaporation at the same time. Generally employed as a dry ambience into which the emulsified dispersion is sprayed is a gas comprised of heated gas such as air, nitrogen, carbonic acid gas, or combustion gas, and especially various gas flows heated to higher than the boiling point of the solvent which has the highest boiling point among those used. The target quality is fully obtained by a short time process employing a spray drier, a belt drier, or a rotary kiln.

### (Coagulation Method of Resin Particles)

In the case in which minute particles are dispersed in water in a charged state, employed as aggregation methods are a method in which electrolytes are added to compress an electric double layer so that particles aggregate to each other, a method in which water-soluble polymers of a high molecular weight are adsorbed onto each particle to result in aggregation, a method in which substances, having a charge opposite that of the used surface active agents and dispersing agents, are added to neutralize the surface charge of minute particles, resulting in aggregation, and a method in which dispersion stability is weakened by varying the counter ions of adsorbing surface active agents or dispersing agents, or solubility of surface active agents or dispersing agents in a water-based medium by adding other substances to the water-based medium so that aggregation results.

While the present invention includes a process to coagulating the resin particles, the resin particles to be provided to be coagulated according to the present invention include those in a state containing an organic solvent, and liquid drop of the resin solution, for example, is included in this category.

It is possible to minimize blocking among toner particles during storage at high temperature, by providing releasing property to the produced toner during fixing by performing aggregation together with the above-mentioned releasing agent emulsion or minute resin particles having a polar group, by enhancing triboelectricity, or by arranging minute resin particles having a relatively high glass transition point in the exterior side.

Employed as electrolyte aggregating agents may be common inorganic or organic water-soluble salts represented by, for example, sodium sulfate, ammonium sulfate, potassium sulfate, magnesium sulfate, sodium phosphate, sodium dihydrogenphosphate, disodium monohydrogenphosphate, ammonium chloride, calcium chloride, cobalt chloride, strontium chloride, cesium chloride, barium chloride, nickel chloride, magnesium chloride, rubidium chloride, sodium chloride, potassium chloride, sodium acetate, ammonium acetate, potassium acetate, and sodium benzoate. In the case in which univalent electrolytes are employed, their concentration is commonly in the range of 0.01-2.0 mol/L, is preferably in the range of 0.1-1.0 mol/L, and is more preferably in the range of 0.2-0.8 mol/L. When multivalent electrolytes are employed, the added amount is allowed to be less than the above. When the aggregating agents are surface active agents, those described above may be employed, while when they are polymer based ones, of those which form polymer protective colloids, ones having an ultra-high molecular weight are suitable. Further, employed as substances which result in aggregation by degrading the dispersion stability due to the presence in water-based media may be ethanol, butanol, isopropanol, ethyl cellosoive, butyl cellosolve, dioxane, tetrahydrofuran, acetone, and methyl ethyl ketone, all of which are water-soluble organic compounds.

Further, by heating the dispersion after aggregation, it is possible to control the shape of formed toner particles. Toner particles tend to be spherical due to interfacial tension. However, at that time, it is possible to optionally control the particle shape from a sphere to an irregular shape by controlling heating temperature, toner viscosity, and the presence of organic solvents.

The resulting dispersion comprised of aggregated particles is sprayed into a dry ambience and water-insoluble organic solvents remaining in the aggregated particles are completely removed, whereby it is possible to form minute toner particles and simultaneously to remove water-based dispersing agents by evaporation. Commonly employed as a dry ambience into which the aggregated particle dispersion is sprayed is heated air, nitrogen, carbonic acid gas, or combustion gas, and especially various gas flows heated to higher than the boiling point of the solvent, which has the highest boiling point among those used. The target quality is fully obtained by a short time process employing a spray drier, a belt drier, or a rotary kiln. When an operation is repeatedly performed in which solid is separated from liquid prior to drying and re-dispersion (a re-slurrying) is performed by adding washing water, it is possible to remove most of the used dispersing agents and emulsifiers.

When compounds such as calcium phosphate, which are soluble in acid and alkali, are employed as a dispersion stabilizer, calcium phosphor is removed from the minute particles, employing a method in which after dissolving calcium phosphate in acid such as hydrochloric acid, washing is performed. As another method, it is possible to remove calcium phosphate by decomposition employing enzymes.

Generally, the particle size distribution after the aggregation operation is narrow and the resulting particles are employed as a toner without any modification. However, when the particle size distribution is broad, and washing and drying are carried out while maintaining the particle size distribution, it is possible to control the particles size distribution to that desired by classifying particles in an air flow.

Classification operation is performed in a liquid employing a cyclone, a decanter, or a centrifuge whereby it is possible to remove the minute particle portions. Naturally, the classification operation may be performed after yielding powder by drying. However, in view of efficiency, it is preferable that the classification is performed in a liquid. The resulting unnecessary minute particles or coarse particles may be returned to the liquid in which the toner components are dissolved so that they are used to form particles. The minute particles or coarse particles may be employed even though they are in a wet state. Dispersing agents employed in the aforesaid classification operation can be removed at the same time when the unnecessary minute particles are removed.

After drying the resulting toner powder may be blended with different kinds of particles such as minute releasing agent particles, minute static charge control agent particles, minute fluidizing agent particles, or minute colorant particles. Further, it is possible to minimize liberation of different kinds of particles from the surface of composite particles which are prepared in such a manner that different kinds of particles are fixed or fused on the surface by applying mechanical impact to the mixed powder.

Specific means include a method in which impact force is applied to the mixture employing blades rotating at a high rate and a method in which a mixture is charged into a high speed air flow and is accelerated so that each particle or composite particle is subjected to collision on a suitable collision board. Listed as such apparatuses are the ANG Mill (manufactured by Hosokawa Micron Corp.), an apparatus which is prepared by modifying a Type I Mill (manufactured by Nippon Pneumatic MFG. Co. Ltd.) to lower the crashing air pressure, the Hybridization System (manufactured by Nara Kikai Seisakusho), the Kryptron System (manufactured by Kawasaki Heavy Industries, Ltd.), and an automatic mill.

### <Physical Property and Shape of Toner Particles>

### (Physical Properties and Shape of Toner Particles)

The acid value of the toner particles of the present invention is preferably 5-30 KOH mg/g. In the present invention, it is assumed that by regulating the afore mentioned acid value of toner particles, during preparation of toner particles, aggregation is carried out in such a state that dispersion stability of resin particles and colorant particles is enhanced, and it may contribute to prepare the toner which overcomes the problems.

It is possible to regulate the acid value to the specified value in the addition polymerization reaction, depending on the composition ratio of the acid component, having a carboxyl group, such as an acrylic acid based monomer, and in a multiple stage polymerization, in its structure. Further, when the polycondensation reaction is employed, it is possible to achieve the acid value in such a manner that by introducing a multifunctional acid such as trimellitic acid, the reaction is terminated so that no further crosslinking reaction is initiated. Further, it is possible to regulate it by controlling the ratio of the acid component to the alcohol component in the synthesis stage. Further, it is possible to regulate it by changing synthesis reaction conditions.

“Acid value”, as described in the present invention, refers to the weight of potassium hydroxide in mg which is necessary to neutralize polar groups such as a carboxyl group, which are incorporated in 1 g of resins and toner. A sample is dissolved in a benzene-ethanol mixed solvent and is titrated with a potassium hydroxide solution the strength of which is precisely known. Subsequently, acid value is calculated based on the amount required for neutralization.

Cited as its specific measurement method may, for example, be the method described in JIS K0070 1992.

The shape of the toner particles used the present invention will now be described. Measurement is carried out for at least 2,000 toner particles at a diameter of at least 1 μm. The average value of circularity (being a shape factor) represented by the following formula is preferably 0.95-0.99, and more preferably 0.94-0.97.

Circularity=(peripheral length of equivalent circle)/(peripheral length of projective image of the toner particle)=2π×(projective area of particle/π)^{1/2}/(peripheral length of projective image of the toner particle)

“Equivalent circle”, as described herein, refers to a circle which has the same area as that of the projective image of the toner particle, and “circle equivalent diameter” refers to the diameter of the above equivalent circle.

It is possible to determine the above circularity employing FPIA-2000 (produced by Sysmex Co.). In this case, the circle equivalent diameter is defined via the following formula.

Circle equivalent diameter=2×(projective area of particle/π)^{1/2}

Further, with regard to the shape of the toner particles of the present invention, the average circle equivalent diameter is preferably 2.6-7.4 μm and the gradient of the circularity to the circle equivalent diameter is preferably −0.050 to −0.010, while the average circle equivalent diameter is more preferably 3.4-6.6 μm and the gradient of the circularity to the circle equivalent diameter is preferably −0.040 to −0.020.

The gradient of the circle equivalent diameter is obtained as follows. The circle equivalent diameter of each of toner particles is determined employing a flow system particle image analyzer FPIA-2000. Subsequently, the relationship of the corresponding circularity is drawn employing the circle equivalent diameter (in μm) as the abscissa and the circularity as the ordinate. When the resulting first order correlation (y=αx+b) is obtained, α shows the gradient of the circle equivalent diameter.

At that time, in view of enhancing charging uniformity and uniform halftone, R² (being the square of R) is preferably 0.35-0.95. Herein, r is represented by following Formula (I):

R=A/B Formula (I)

wherein A and B each represent the following formula.

A=nΣXY−(ΣXΣY)

B=(nΣX²−(ΣX)²×((nΣY²)−(ΣY)²)

wherein X represents the circle equivalent diameter (in μm), and Y represents the circularity.

When toner particles of a specified gradient of the circle equivalent diameter are prepared, spherical toner particles at a smaller diameter may be blended with non-spherical toner particles of a relatively larger diameter. Alternatively, the following method may be employed. When toner particles are prepared via coalescence of resin particles, after the addition of coagulants in the coalescence process, the shape of stirring blades is appropriately selected. Subsequently, while controlling the magnitude of stirring, conditions are set so that shearing force tends to be applied to the relatively larger particles, followed by filtration and drying processes. It is preferable that production is carried out in such a manner that the above flow system particle image analyzer is subjected to in-line connection to the toner production apparatus, and production is carried out while appropriately controlling conditions by monitoring the average circularity and gradient α.

It is possible to control the size of toner particles within the above range in such a manner that after charging of terminating agents to terminate salting-out/fusion, toner particles are allowed to grow further 0.2-1.0 μm, for example, via re-addition of salting-out agents and addition of surface active agents.

Further, in view of optimization of a charge amount distribution of toner particles, ratio d₉₀/d₁₀ is preferably 1.2-2.0, but is most preferably 1.3-1.8, wherein d₁₀ represents the circle equivalent diameter of the toner particle at a cumulative 10% by number of the smallest toner particle, and d₉₀ represents the circle equivalent diameter of the toner particle at a cumulative 90% by number. When the above ratio is regulated within the above range, it is possible to control dots near characters, whereby it is possible to produce high quality images with high halftone uniformity.

### (Developers)

The toner of the present invention can be employed as a single-component or double-component developer. The single-component developer is preferably employed due to the fact that toner particles have a shape which easily rolls, sufficient negative charging property is realized, and further, relatively high particle strength tends to be achieved. When conventional coalescent type toner is employed as a single-component developer to produce images, toner particles are crushed due to application of pressure of a thin layer forming member. However, the toner particles according to the present invention are not crushed and in addition, neither fusion nor stain due to toner flaking onto the development roller occurs, and stable image formation is achievable.

When employed as a single-component developer, listed are a non-magnetic single-component toner and a magnetic single-component toner in which 0.1-0.5 μm magnetic particles are incorporated, and both are usable.

The toner particles exhibit high strength and strong negative charging property and the toner according to the present invention is particularly suitable for the single-component developer.

The toner prepared by the fusion method exhibits the above characteristics, and the reasons are assumed to be as follows.

Initially, it is assumed that the high strength of the toner particles is generated in such a manner that since during production of toner particles, resin particles (or resin solution droplets) are aggregated at the molecular level while fused, the particles are strongly aggregated with each other.

It is further assumed that since toner particles are formed as nearly a sphere, the toner particle is not crushed under application of stress while clearing off the applied stress.

Secondly, reasons which realize the strong negative charging property are assumed that toner particles are rounded to roll easily, whereby frictional electrification is efficiently carried out.

Further, resins which constitute the toner particles according to the present invention, exhibit a low elastic modulus in an aqueous medium and tend to be modified after aggregation, whereby excellent effects also result in cleaning property.

The toner particle may be used as the double-component developer by mixing with a carrier. In such the case, known materials such as iron, ferrite and magnetite and their alloys with another metal such as aluminum and lead are employable as the magnetic particle of the carrier. The ferrite particle is particularly preferred. The magnetic particles preferably have a volume average particle diameter of from 15-100 μm and more preferably from 25-80 μm.

The volume average particle diameter can be typically measured by a laser diffraction particle distribution measuring apparatus provided with a wet dispersion device HELOS manufactured by Sympatec Co., Ltd.

The carrier is preferably a carrier in which the magnetic particle is coated with resin or a resin dispersed carrier in which the magnetic particle is dispersed in resin. The composition of the resin for the coating is not specifically limited, for example, olefin type resins, styrene type resins, styrene-acryl type resins, silicone type resins and fluorinated type resins are employed. For the resin constituting resin dispersed carrier, known ones can be employed without any limitation, for example, styrene-acryl type resins, polyester type resins, fluorinated type resins and phenol resins can be employed

### EXAMPLE

The invention is explained concretely by referring examples below, however the invention is not restricted to these.

### Preparation of Toner 101

### (Preparation of Toner Origin A)

(Preparation of Latex 6HML)

### (1) Preparation of Core Particle (The First Step of Polymerization): Preparation of Latex 6H

Into a 5,000 ml separable flask, to which a stirring device, a thermal sensor, a cooling pipe and a nitrogen gas introducing device are attached, a surfactant solution (aqueous medium) composed of 3,010 g of deionized water and 7.08 g of an anionic surfactant, sodium lauryl sulfate, dissolved in the deionized water was charged and heated by 80° C. while stirring at a stirring rate of 230 rpm.

To the surfactant solution, an initiator solution composed of 400 g of deionized water and 9.2 g of a polymerization initiator (potassium persulfate: KPS) dissolved therein was added and then the temperature was adjusted to 75° C. After that, a mixture of monomers composed of 69.4 g of styrene, 28.3 g of n-butyl acrylate, and 2.30 g of methacrylate was dropped spending 1 hour. The system was heated and stirred at 75° C. for 2 hours to perform the polymerization (the first step polymerization) to form latex (dispersion of resin particles composed of high molecular weight resin). The latex was referred to as Latex 6H.

### (2) Formation of Intermediate Layer (Second Step of Polymerization): Preparation of Latex 6HM

A monomer solution was prepared by adding 98.0 g of compound represented by the following Formula, to a monomer mixture liquid composed of 97.1 g of styrene, 39.7 g of n-butyl acrylate, 3.22 g of methacrylic acid and 5.6 g of n-octyl-3-mercaptopropionic acid ester at 90° C. in a flask to which a stirring device was attached.

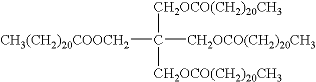

On the other hand, a surfactant solution composed of 2,700 ml of deionized water and, dissolved therein, 1.6 g of an anionic surfactant, sodium lauryl sulfate, was heated up to 98° C. and 28 g in terms of solid ingredient of Latex 6H which is a dispersion of the core particles was added to the surfactant solution. Then the above prepared monomer solution of Exemplified Compound 19 was mixed and dispersed for 8 hours in the above resulted liquid by a mechanical dispersing apparatus having a circulation pass CLEARMIX manufactured by M Technique Co., Ltd., to prepare a dispersion (emulsion) containing emulsified particles (oil droplets).

After that, an initiator liquid composed of 240 ml of deionized water and 5.1 g of the polymerization initiator (KPS) dissolved therein, and 750 ml of deionized water was added to the dispersion liquid (emulsion), the system was heated and stirred for 12 hours at 98° C. to perform polymerization (second step polymerization). Thus latex was obtained which was referred to as Latex 6HM, which is a dispersion liquid of composite resin particles having a structure that the surface of resin particles composed of the high molecular weight resin is covered with a resin having medium molecular weight.

### (3) Preparation of Outer Layer (The Third Step of Polymerization): Preparation of Latex 6HML

To thus obtained Latex 6HM, an initiator solution composed of 200 ml of deionized water and 7.4 g of the polymerization initiator (KPS) dissolved therein was added and then a monomer mixture liquid composed of 277 g of styrene, 113 g of n-butyl acrylate, 9.21 g of methacrylic acid and 10.4 g of n-octyl-3-mercaptopropionic acid ester was dropped to the latex spending for 1 hour at a temperature condition of 80° C. After completion of the dropping, the resulted liquid was heated and stirred for 1 hour for polymerization (third step polymerization), and then cooled by 28° C. to obtain latex. Thus obtained latex was referred to as Latex 6HML.

### (Preparation of Toner Origin A)

Black colored particles, Toner Origin A, was prepared as follows.

(1) Preparation of Colorant Dispersion 1

In 1,600 ml of deionized water, 90 g of the anionic surfactant was dissolved by stirring. To the solution, 400.0 g of carbon black Regal 330R manufactured by Cabot Co., Ltd., was gradually added while stirring, and then dispersed by the stirring apparatus CLEAMIX manufactured by M Technique Co., Ltd. so as to obtain the colorant particles having particle diameter of less than 200 nm, and dispersion of a colorant was obtained. The dispersion was referred to as Colorant Dispersion 1.

(2) (Coagulation•Fusion) Preparation of Coagulated Particles

Into a reaction vessel (four-mouth flask) to which a thermal sensor, a cooling tube, a nitrogen gas introducing device and a stirring device were attached, 200 g in terms of solid ingredient of Latex 6HML, 3,000 g of deionized water and 71 g of Colorant Dispersion 1 were charged. The inner temperature of the vessel was adjusted to 30° C. and then the pH value of the liquid was adjusted to 8-11.0 by adding a 5 mol/L aqueous solution of sodium hydroxide. After that, a solution composed of 20 ml of deionized water and, dissolved therein, 20 g of magnesium chloride hexahydrate was dropped to the above liquid spending for 10 minutes at 30° C. The liquid was stood for 3 minutes and then heated up to 75° C. spending 60 minutes. Under such the conditions, the diameter of the associated particle was measured by Coulter Counter MS-II, and an aqueous solution composed of 60 ml of deionized water and, dissolved therein, 29 g of sodium succinate was added at a time when the number average diameter of the particles was attained at 6-7 μm to stop the growing the particles. Moreover, the fusion of the particles was continued as a ripening treatment by heating and stirring for 6 hours at 90° C. After that temperature was cooled down to 30° C., pH was adjusted to 2.0 with hydrochloric acid, then stirring was terminated. Thus formed particles of salted out, coagulated and fused were filtrated and washed repeatedly with deionized water at 45° C. Black Colored particles Toner Origin A was obtained by drying warm air at 40° C.

Toner origins B-E employed for Toner 102-110 and Toner 202-210 are shown below.

### (Preparation of Toner Origin B)

(Preparation of Latex 8HML)

### (1) Preparation of Core Particle (The First Step of Polymerization): Preparation of Latex 8H

Into a 5,000 ml separable flask, to which a stirring device, a thermal sensor, a cooling pipe and a nitrogen gas introducing device are attached, a surfactant solution (aqueous medium) composed of 3,010 g of deionized water and 7.08 g of an anionic surfactant, sodium lauryl sulfate, dissolved in the deionized water was charged and heated by 80° C. while stirring at a stirring rate of 230 rpm.

To the surfactant solution, an initiator solution composed of 200 g of deionized water and 9.2 g of a polymerization initiator (potassium persulfate: KPS) dissolved therein was added and then the temperature was adjusted to 75° C. After that, a mixture of monomers composed of 70.3 g of styrene, 28.7 g of n-butyl acrylate, and 1.00 g of methacrylic acid was dropped spending 1 hour. The system was heated and stirred at 75° C. for 2 hours to perform the polymerization (the first step polymerization) to form latex (dispersion of resin particles composed of high molecular weight resin). The latex was referred to as Latex 8H.

### (2) Formation of Intermediate Layer (Second Step of Polymerization): Preparation of Latex 8HM

A monomer solution was prepared by adding 98.0 g of crystallization substance, Compound A, to a monomer mixture liquid composed of 98.3 g of styrene, 40.2 g of n-butyl acrylate, 1.51 g of methacrylic acid and 5.6 g of n-octyl-3-mercaptopropionic acid ester at 90° C. in a flask to which a stirring device was attached.

On the other hand, a surfactant solution composed of 2,700 ml of deionized water and, dissolved therein, 1.6 g of an anionic surfactant, sodium lauryl sulfate, was heated up to 98° C. and 28 g in terms of solid ingredient of Latex 5H which is a dispersion of the core particles was added to the surfactant solution, then they were mixed and dispersed for 8 hours in the above resulted liquid by a mechanical dispersing apparatus having a circulation pass CLEARMIX manufactured by M Technique Co., Ltd., to prepare a dispersion (emulsion) containing emulsified particles (oil droplets).

After that, an initiator liquid composed of 240 ml of deionized water and 5.1 g of the polymerization initiator (KPS) dissolved therein, and 750 ml of deionized water was added to the dispersion liquid (emulsion), the system was heated and stirred for 12 hours at 98° C. to perform polymerization (second step polymerization). Thus latex was obtained which was referred to as Latex 8HM, which is a dispersion liquid of composite resin particles having a structure that the surface of resin particles composed of the high molecular weight resin is covered with a resin having medium molecular weight.

### (3) Preparation of Outer Layer (The Third Step of Polymerization): Preparation of Latex 8HML

To thus obtained Latex 8HM, an initiator solution composed of 200 ml of deionized water and 7.4 g of the polymerization initiator (KPS) dissolved therein was added and then a monomer mixture liquid composed of 283 g of styrene, 115 g of n-butyl acrylate, 4.30 g of methacrylic acid and 10.4 g of n-octyl-3-mercaptopropionic acid ester was dropped to the latex spending for 1 hour at a temperature condition of 80° C. After completion of the dropping, the resulted liquid was heated and stirred for 2 hour for polymerization (third step polymerization), and then cooled by 28° C. to obtain latex. Thus obtained latex was referred to as Latex 8HML.

### (Preparation of Toner Origin B)

Toner Origin B was prepared in the same preparation way as Toner Origin A except that Latex 6HML was replaced by Latex 8HML.

### (Preparation of Toner Origin C)

(Preparation of Latex 4HML)

### (1) Preparation of Core Particle (The First Step of Polymerization): Preparation of Latex 4H

Into a 5,000 ml separable flask, to which a stirring device, a thermal sensor, a cooling pipe and a nitrogen gas introducing device are attached, a surfactant solution (aqueous medium) composed of 3,010 g of deionized water and 7.08 g of an anionic surfactant, sodium lauryl sulfate, dissolved in the deionized water was charged and heated by 80° C. while stirring at a stirring rate of 230 rpm.

To the surfactant solution, an initiator solution composed of 200 g of deionized water and 9.2 g of a polymerization initiator (potassium persulfate: KPS) dissolved therein was added and then the temperature was adjusted to 75° C. After that, a mixture of monomers composed of 74.5 g of styrene, 21.6 g of n-butyl acrylate, and 1.93 g of acrylic acid was dropped spending 1 hour. The system was heated and stirred at 75° C. for 2 hours to perform the polymerization (the first step polymerization) to form latex (dispersion of resin particles composed of high molecular weight resin). The latex was referred to as Latex 4H.

### (2) Formation of Intermediate Layer (Second Step of Polymerization) Preparation of Latex 4HM

A monomer solution was prepared by adding 98.0 g of crystallization substance, Compound A, to a monomer mixture liquid composed of 104 g of styrene, 30.2 g of n-butyl acrylate, 2.7 g of acrylic acid and 5.6 g of n-octyl-3-mercaptopropionic acid ester at 90° C. in a flask to which a stirring device was attached.

On the other hand, a surfactant solution composed of 2,700 ml of deionized water and, dissolved therein, 1.6 g of an anionic surfactant, sodium lauryl sulfate, was heated up to 98° C. and 28 g in terms of solid ingredient of Latex 4H which is a dispersion of the core particles was added to the surfactant solution, then they were mixed and dispersed for 8 hours in the above resulted liquid by a mechanical dispersing apparatus having a circulation pass CLEARMIX manufactured by M Technique Co., Ltd., to prepare a dispersion (emulsion) containing emulsified particles (oil droplets).

After that, an initiator liquid composed of 240 ml of deionized water and 5.1 g of the polymerization initiator (KPS) dissolved therein, and 750 ml of deionized water was added to the dispersion liquid (emulsion), the system was heated and stirred for 12 hours at 98° C. to perform polymerization (second step polymerization). Thus latex was obtained which was referred to as Latex 4HM, which is a dispersion liquid of composite resin particles having a structure that the surface of resin particles composed of the high molecular weight resin is covered with a resin having medium molecular weight. The latex was referred to as Latex 4HM.

### (3) Preparation of Latex 4HML (Preparation of Outer Layer: The Third Step of Polymerization):

To thus obtained Latex 8HM, an initiator solution composed of 200 ml of deionized water and 7.4 g of the polymerization initiator (KPS) dissolved therein was added and then a monomer mixture liquid composed of 306 g of styrene, 88.5 g of n-butyl acrylate, 17.4 g of acrylic acid and 10.4 g of n-octyl-3-mercaptopropionic acid ester was dropped to the latex spending for 2 hour at a temperature condition of 80° C. After completion of the dropping, the resulted liquid was heated and stirred for 2 hour for polymerization (third step polymerization), and then cooled by 28° C. to obtain latex. Thus obtained latex was referred to as Latex 4HML.

### (Preparation of Toner Origin C)

Toner Origin C was prepared in the same preparation way as Toner Origin A except that Latex 6HML was replaced by Latex 4HML.

### (Preparation of Toner Origin D)

(Preparation of Latex 12HML)

### (1) Preparation of Core Particle (The First Step of Polymerization): Preparation of Latex 12H

Into a 5,000 ml separable flask, to which a stirring device, a thermal sensor, a cooling pipe and a nitrogen gas introducing device are attached, a surfactant solution (aqueous medium) composed of 3,010 g of deionized water and 7.08 g of an anionic surfactant, sodium lauryl sulfate, dissolved in the deionized water was charged and heated by 80° C. while stirring at a stirring rate of 230 rpm.

To the surfactant solution, an initiator solution composed of 200 g of deionized water and 9.2 g of a polymerization initiator (potassium persulfate: KPS) dissolved therein was added and then the temperature was adjusted to 75° C. After that, a mixture of monomers composed of 70.7 g of styrene, 28.9 g of n-butyl acrylate, and 0.386 g of acrylic acid was dropped spending 1 hour. The system was heated and stirred at 75° C. for 2 hours to perform the polymerization (the first step polymerization) to form latex (dispersion of resin particles composed of high molecular weight resin). The latex was referred to as Latex 12H.

### (2) Formation of Intermediate Layer (Second Step of Polymerization): Preparation of Latex 12HM

A monomer solution was prepared by adding 98.0 g of crystallization substance, Compound A, to a monomer mixture liquid composed of 99.0 g of styrene, 40.4 g of n-butyl acrylate, 0.54 g of acrylic acid and 5.6 g of n-octyl-3-mercaptopropionic acid ester at 90° C. in a flask to which a stirring device was attached.

On the other hand, a surfactant solution composed of 2,700 ml of deionized water and, dissolved therein, 1.6 g of an anionic surfactant, sodium lauryl sulfate, was heated up to 98° C. and 28 g in terms of solid ingredient of Latex 4H which is a dispersion of the core particles was added to the surfactant solution, then they were mixed and dispersed for 8 hours in the above resulted liquid by a mechanical dispersing apparatus having a circulation pass CLEARMIX manufactured by M Technique Co., Ltd., to prepare a dispersion (emulsion) containing emulsified particles (oil droplets).

After that, an initiator liquid composed of 240 ml of deionized water and 5.1 g of the polymerization initiator (KPS) dissolved therein, and 750 ml of deionized water was added to the dispersion liquid (emulsion), the system was heated and stirred for 12 hours at 98° C. to perform polymerization (second step polymerization). Thus latex was obtained which was referred to as Latex 4HM, which is a dispersion liquid of composite resin particles having a structure that the surface of resin particles composed of the high molecular weight resin is covered with a resin having medium molecular weight. The latex was referred to as Latex 12HM.

### (3) Preparation of Outer Layer (The Third Step of Polymerization): Preparation of Latex 12HML

To thus obtained Latex 12HM, an initiator solution composed of 200 ml of deionized water and 7.4 g of the polymerization initiator (KPS) dissolved therein was added and then a monomer mixture liquid composed of 281 g of styrene, 114.8 g of n-butyl acrylate, 1.54 g of acrylic acid and 10.4 g of n-octyl-3-mercaptopropionic acid ester was dropped to the latex spending for 2 hour at a temperature condition of 80° C. After completion of the dropping, the resulted liquid was heated and stirred for 2 hour for polymerization (third step polymerization), and then cooled by 28° C. to obtain latex. Thus obtained latex was referred to as Latex 12HML.

### (Preparation of Toner Origin D)

Toner Origin D was prepared in the same preparation way as Toner Origin A except that Latex 12HML was employed in place of Latex 6HML.

### (Preparation of Toner Origin E)

### (1) Preparation of Core Particle (The First Step of Polymerization): Preparation of Latex 9H

Into a 5,000 ml separable flask, to which a stirring device, a thermal sensor, a cooling pipe and a nitrogen gas introducing device are attached, a surfactant solution (aqueous medium) composed of 3,010 g of deionized water and 7.08 g of an anionic surfactant, sodium lauryl sulfate, dissolved in the deionized water was charged and heated by 80° C. while stirring at a stirring rate of 230 rpm.

To the surfactant solution, an initiator solution composed of 200 g of deionized water and 9.2 g of a polymerization initiator (potassium persulfate: KPS) dissolved therein was added and then the temperature was adjusted to 75° C. After that, a mixture of monomers composed of 67.8 g of styrene, 27.7 g of n-butyl acrylate, and 4.50 g of methacrylic acid was dropped spending 1 hour. The system was heated and stirred at 75° C. for 2 hours to perform the polymerization (the first step polymerization) to form latex (dispersion of resin particles composed of high molecular weight resin). The latex was referred to as Latex 9H.

### (2) Formation of Intermediate Layer (Second Step of Polymerization): Preparation of Latex 9HM

A monomer solution was prepared by adding 98.0 g of crystallization substance, Compound A, to a monomer mixture liquid composed of 94.1 g of styrene, 38.4 g of n-butyl acrylate, 7.53 g of methacrylic acid and 5.6 g of n-octyl-3-mercaptopropionic acid ester at 90° C. in a flask to which a stirring device was attached.

On the other hand, a surfactant solution composed of 2,700 ml of deionized water and, dissolved therein, 1.6 g of an anionic surfactant, sodium lauryl sulfate, was heated up to 98° C. and 28 g in terms of solid ingredient of Latex 9H which is a dispersion of the core particles was added to the surfactant solution, then they were mixed and dispersed for 8 hours in the above resulted liquid by a mechanical dispersing apparatus having a circulation pass CLEARMIX manufactured by M Technique Co., Ltd., to prepare a dispersion (emulsion) containing emulsified particles (oil droplets).

After that, an initiator liquid composed of 240 ml of deionized water and 5.1 g of the polymerization initiator (KPS) dissolved therein, and 750 ml of deionized water was added to the dispersion liquid (emulsion), the system was heated and stirred for 12 hours at 98° C. to perform polymerization (second step polymerization). Thus latex was obtained which was referred to as Latex 4HM, which is a dispersion liquid of composite resin particles having a structure that the surface of resin particles composed of the high molecular weight resin is covered with a resin having medium molecular weight. The latex was referred to as Latex 9HM.

### (3) Preparation of Outer Layer (The Third Step of Polymerization): Preparation of Latex 9HML

To thus obtained Latex 9HM, an initiator solution composed of 200 ml of deionized water and 7.4 g of the polymerization initiator (KPS) dissolved therein was added and then a monomer mixture liquid composed of 269 g of styrene, 110 g of n-butyl acrylate, 21.5 g of acrylic acid and 10.4 g of n-octyl-3-mercaptopropionic acid ester was dropped to the latex spending for 2 hour at a temperature condition of 80° C. After completion of the dropping, the resulted liquid was heated and stirred for 2 hour for polymerization (third step polymerization), and then cooled by 28° C. to obtain latex. Thus obtained latex was referred to as Latex 9HML.

### (Preparation of Toner Origin E)

Toner Origin E was prepared in the same preparation way as Toner Origin A except that Latex 9HML was employed in place of Latex 6HML.

### (Preparation of Toner 101)

### (Treatment 1 of Titanic Acid Compound)

In the wet system sizing process of strontium titanate (being a titanic acid compound), primary sizing was carried out by adding dimethyl polysiloxane (being silicone oil) in an amount of 1.0% by weight based on the total weight of strontium titanate.

Thereafter, drying was conducted and secondary sizing was carried out employing a flash system pulverizer, whereby a silicon oil-treated titanic acid compound was prepared.

### (External Addition to Toner Origin A)

Added to Toner Origin A, prepared as above, were 1.0% by weight of hydrophobic silica (CAB-O-SIL TG-811F, produced by Cabot Corporation), and 1.0% by weight of NX90 (produced by Nippon Aerosil Co., Ltd.), and the resulting mixture was mixed via a Henschel mixer (produced by Mitsui Mining and Smelting Co., Ltd.). Thereafter, coarse particles were removed employing a 45 μm opening sieve, whereby Toner 101 was prepared.

### (Preparation Toners 102-110)

Toners 102-110 were prepared in the same manner as Toner 101, except that the toner origin (type and acid value), the titanic acid compound (type, number average radius of primary particles, and added amount to the toner origin), and silicone oil (type, and added amount to the titanic acid compound) were changed as listed in Table 1-1. Toner 110 was not subjected to the silicone oil treatment.

TABLE 1-1

| | | Titanic Acid Compound | | | | | |
|---|---|---|---|---|---|---|---|
| | Toner | | Particle | | Silicone Oil | | |
| Toner | Origin | | diameter | Amount | | Amount | |
| No. | No. | Compound | (*) | (wt %) | Compound | (wt %) | Remarks |
| 101 | A | Strontium titanate | 870 nm | 2.0 | Dimethyl polysiloxane | 1.0 | Invention |
| 102 | A | Barium titanate | 600 nm | 1.5 | Dimethyl polysiloxane | 1.0 | Invention |
| 103 | A | Calcium titanate | 560 nm | 1.0 | Dimethyl polysiloxane | 1.0 | Invention |
| 104 | A | Calcium titanate | 320 nm | 0.5 | Methyl hydrogen | 2.0 | Invention |
| | | | | | polysiloxane | | |
| 105 | B | Calcium titanate | 150 nm | 2.8 | Methyl phenyl | 3.5 | Invention |
| | | | | | polysiloxane | | |
| 106 | C | Calcium titanate | 1200 nm | 0.3 | Methyl phenyl | 0.5 | Invention |
| | | | | | polysiloxane | | |
| 107 | D | Strontium titanate | 560 nm | 1.0 | Dimethyl polysiloxane | 1.0 | Invention |
| 108 | E | Strontium titanate | 560 nm | 1.0 | Dimethyl polysiloxane | 1.0 | Invention |
| 109 | C | Strontium titanate | 2560 nm | 1.0 | Dimethyl polysiloxane | 0.5 | Invention |
| 110 | A | Calcium titanate | 560 nm | 1.0 | None | — | Comparative |

(*): Number average primary particle diameter

### (Preparation of Toner 201)

### (Treatment 2 of Titanic Acid Compound)

Under vigorous stirring, added to an acid solution adjusted to a pH of 4, employing 1 mol/L hydrochloric acid, was strontium titanate (being a titanic acid compound) at a temperature higher then the boiling point of the acid solution. Subsequently, the resulting strontium titanate solution was diluted with toluene, followed by dripping of 3% by weight methyltrialkoxysilane (being a coupling agent) at a constant rate. After dripping, stirring was continued awhile while maintaining the temperature, whereby the coupling treatment was completed. After sufficient drying, sizing was carried out employing a flash system pulverizer, whereby a coupling agent treated-titanic acid compound was prepared.

### (External Addition to Toner Origin A)

Added to Toner Origin A, prepared as above, were 2.0% by weight of the titanic acid compound treated with the coupling agent, 1.0% by weight of hydrophobic silica (CAB-O-SIL TG-811F, produced by Cabot Corporation), and 1.0% by weight of NX90 (produced by Nippon Aerosil Co., Ltd.), and the resulting mixture was mixed employing a Henschel mixer (produced by Mitsui Mining Co., Ltd.). Thereafter, coarse particles were removed via a 45 μm opening sieve, whereby Toner 201 was prepared.

### (Preparation of Toners 202-210)

Toners 202-210 were prepared in the same manner as Toner 201, except that the toner origin (type and acid value), the titanic acid compound (type, number average radius of primary particles, and added amount to the toner origin), and the coupling agent (type, and added amount to the titanic acid compound) were changed as listed in Table 2-1. Toner 210 was not subjected to the coupling agent treatment.

TABLE 2-1

| | Toner | Titanic Acid Compound | | | Coupling agent | | |
|---|---|---|---|---|---|---|---|
| Toner | Origin | | Particle | Amount | | Amount | |
| No. | No. | Compound | diameter (*) | (wt %) | Compound | (wt %) | Remarks |
| 201 | A | Strontium titanate | 870 nm | 2.0 | Methyl triethoxy silane | 3.0 | Invention |
| 202 | A | Barium titanate | 600 nm | 1.5 | Methyl triethoxy silane | 3.0 | Invention |
| 203 | A | Calcium titanate | 560 nm | 1.0 | Methyl triethoxy silane | 3.0 | Invention |
| 204 | A | Calcium titanate | 320 nm | 0.5 | Methyl triethoxy silane | 2.0 | Invention |
| 205 | B | calcium titanate | 150 nm | 2.8 | Methyl triethoxy silane | 7.5 | Invention |
| 206 | C | Calcium titanate | 1200 nm | 0.3 | Methyl triethoxy silane | 0.2 | Invention |
| 207 | D | Strontium titanate | 560 nm | 1.0 | Methyl triethoxy silane | 3.0 | Invention |
| 208 | E | Strontium titanate | 560 nm | 1.0 | Methyl triethoxy silane | 3.0 | Invention |
| 209 | C | Strontium titanate | 2560 nm | 1.0 | Methyl triethoxy silane | 0.2 | Invention |
| 210 | A | Calcium titanate | 560 nm | 1.0 | None | — | Comparative |

(*): Number average primary particle diameter

### (Evaluation of Toners)

### (Determination of Acid Value)

Acid value of each of the prepared toners was determined based on to JIS-K0070-1992.

Further, by employing a full-color printer, MAGICOLOR 2300DL (produced by Konica Minolta Technologies, Inc.), equipped with a non-magnetic single-component apparatus, each of the prepared toners was allowed to stand at high temperature and high humidity (30° C. and 85% relative humidity) for 24 hours, and a print pattern at a 6% B/W ratio was printed onto 5,000 sheets and 10,000 sheets. Further, after the toner was allowed to stand at low temperature and low humidity (10° C. and 15% relative humidity) for 24 hours, a print pattern at a 6% B/W ratio was printed onto 10,000 sheets. Thereafter, image density, fog, and (at low temperature and low humidity, halftone slight touching and spot defects) were evaluated.

### (Image Density)

After completion of printing, the absolute density of a solid image portion on the sheet was determined employing MACBETH REFLECTION DENSITOMETER “RD-918”.

### (Fog)

After completion of the endurance printing run, a relative density with respect to the sheet was determined.

Absolute densities at 20 positions of a blank sheet were determined employing MACBETH REFLECTION DENSITOMETER “RD-918” and the averaged value was designated as density of the blank sheet. Subsequently, absolute densities at 20 positions of the white portion of the evaluation image were determined and averaged. The value which was obtained by subtracting the above averaged value form the density of the blank sheet was designated as fog density, which was employed for evaluation. Fog density of at most 0.01 was judged to be commercially viable.

### (Slight Touching)

A: at completion of the endurance printing run, no slight touching in
   the halftone of images was noticed
B: some slight touching was noticed but was commercially viable
C: commercially unviable

### (Spot Defects)

At completion of the endurance printing run, a solid image was outputted and image defects, due to abrasion of the photoreceptor, were visually evaluated.

Tables 1-2 and 2-2 show the evaluation results.

TABLE 1-2

| | | HH After | | HH After | | | | | | |
|---|---|---|---|---|---|---|---|---|---|---|
| | | 5,000 | | 10,000 | | | | | | |
| | | prints | | prints | | LL After 10,000 prints | | | | |
| Toner | Acid | Image | | Image | | Image | | Slight | Spot | |
| No. | value | density | Fog | density | Fog | density | Fog | Touching | Defects | Remarks |
| 101 | 15 | 1.42 | 0.001 | 1.42 | 0.000 | 1.42 | 0.000 | A | Not | Invention |
| | | | | | | | | | observed | |
| 102 | 17 | 1.42 | 0.001 | 1.42 | 0.001 | 1.42 | 0.000 | A | Not | Invention |
| | | | | | | | | | observed | |
| 103 | 22 | 1.42 | 0.000 | 1.42 | 0.001 | 1.42 | 0.001 | A | Not | Invention |
| | | | | | | | | | observed | |
| 104 | 15 | 1.42 | 0.001 | 1.42 | 0.000 | 1.42 | 0.001 | A | Not | Invention |
| | | | | | | | | | observed | |
| 105 | 7 | 1.41 | 0.000 | 1.38 | 0.002 | 1.42 | 0.003 | A | Not | Invention |
| | | | | | | | | | observed | |
| 106 | 25 | 1.39 | 0.001 | 1.39 | 0.002 | 1.42 | 0.002 | A | Not | Invention |
| | | | | | | | | | observed | |
| 107 | 3 | 1.42 | 0.000 | 1.42 | 0.002 | 1.36 | 0.001 | B | Not | Invention |
| | | | | | | | | | observed | |
| 108 | 35 | 1.44 | 0.003 | 1.45 | 0.005 | 1.42 | 0.001 | A | Not | Invention |
| | | | | | | | | | observed | |
| 109 | 25 | 1.42 | 0.001 | 1.42 | 0.003 | 1.42 | 0.003 | B | 1 | Invention |
| 100 | 15 | 1.25 | 0.008 | 1.15 | 0.021 | 1.32 | 0.006 | C | 16 | Comparative |

HH: 30° C., 85% RH, 24 hours
LL: 10° C., 15% RH, 24 hours

TABLE 2-2

| | | HH After | | HH After | | | | | | |
|---|---|---|---|---|---|---|---|---|---|---|
| | | 5,000 | | 10,000 | | | | | | |
| | | prints | | prints | | LL After 10,000 prints | | | | |
| Toner | Acid | Image | | Image | | Image | | Slight | Spot | |
| No. | value | density | Fog | density | Fog | density | Fog | Touching | Defects | Remarks |
| 201 | 16 | 1.42 | 0.000 | 1.42 | 0.001 | 1.42 | 0.001 | A | Not | Invention |
| | | | | | | | | | observed | |
| 202 | 15 | 1.42 | 0.001 | 1.42 | 0.000 | 1.42 | 0.001 | A | Not | Invention |
| | | | | | | | | | observed | |
| 203 | 23 | 1.41 | 0.000 | 1.42 | 0.001 | 1.42 | 0.001 | A | Not | Invention |
| | | | | | | | | | observed | |
| 204 | 14 | 1.42 | 0.001 | 1.42 | 0.001 | 1.42 | 0.001 | A | Not | Invention |
| | | | | | | | | | observed | |
| 205 | 6 | 1.42 | 0.001 | 1.35 | 0.002 | 1.42 | 0.003 | A | Not | Invention |
| | | | | | | | | | observed | |
| 206 | 23 | 1.38 | 0.001 | 1.36 | 0.002 | 1.42 | 0.003 | A | Not | Invention |
| | | | | | | | | | observed | |
| 207 | 3 | 1.42 | 0.001 | 1.35 | 0.002 | 1.35 | 0.001 | B | Not | Invention |
| | | | | | | | | | observed | |
| 208 | 38 | 1.44 | 0.003 | 1.33 | 0.003 | 1.42 | 0.001 | A | Not | Invention |
| | | | | | | | | | observed | |
| 209 | 23 | 1.42 | 0.001 | 1.36 | 0.003 | 1.42 | 0.002 | B | 1 | Invention |
| 210 | 15 | 1.25 | 0.008 | 1.17 | 0.021 | 1.32 | 0.006 | C | 16 | Comparative |

HH: 30° C., 85% RH, 24 hours
LL: 10° C., 15% RH, 24 hours

As can be seen from the tables, toners of the present invention result in excellent image density, and minimize fog, slight touching and spot defects, and enable stable formation of high quality images over a long period.

1. An electrostatic image developing toner comprising toner particles containing at least a resin and a colorant, and an external additive, wherein the external additive contains inorganic minute particles having a number average primary particle diameter of 5-30 nm and a titanic acid compound treated by silicone oil or a coupling agent.

2. The electrostatic image developing toner of claim 1 wherein an acid value of the toner particles is 5-30 KOH mg/g.

3. The electrostatic image developing toner of claim 1 wherein a number average primary particle diameter of the titanic acid compound is 100-2,000 nm.

4. The electrostatic image developing toner of claim 1 wherein an added amount of the titanic acid compound is 0.1-10.0% by weight based on the total weight of the toner particles.

5. The electrostatic image developing toner of claim 1 wherein the titanic acid compound is barium titanate, calcium titanate, magnesium titanate or strontium titanate.

6. The electrostatic image developing toner of claim 1 wherein the titanic acid compound is barium titanate, calcium titanate or magnesium titanate.

7. The electrostatic image developing toner of claim 1 wherein an amount of titanic acid compounds is 0.1-10.0% by weight based on the total weight of the toner particles.

8. The electrostatic image developing toner of claim 7 wherein the amount of titanic acid compounds is 0.3-5.0% by weight based on the total weight of the toner particles.

9. The electrostatic image developing toner of claim 8 wherein the amount of titanic acid compounds is 0.4-2.0% by weight based on the total weight of the toner particles.

10. The electrostatic image developing toner of claim 1 wherein the inorganic minute particles are silica, alumina, or titanium oxide.

11. The electrostatic image developing toner of claim 1 wherein an average value of circularity of the toner particles is 0.95-0.99, wherein
Circularity=(peripheral length of equivalent circle)/(peripheral length of projective image of the toner particle).

12. The electrostatic image developing toner of claim 11 wherein the average value of circularity of the toner particles is 0.94-0.97.

13. The electrostatic image developing toner of claim 1 wherein the titanic acid compound is treated by silicone oil.

14. The electrostatic image developing toner of claim 13 wherein an amount of the silicone oil is 0.05-5.0% by weight to titanic acid compound.

15. The electrostatic image developing toner of claim 14 wherein an amount of the silicone oil is 0.5-2.0% by weight to titanic acid compound.

16. The electrostatic image developing toner of claim 13 wherein the silicone oil is a dimethyl polysiloxane, methyl hydrogen polysiloxane or methyl phenyl polysiloxane compound.

17. The electrostatic image developing toner of claim 1 wherein the titanic acid compound is treated by a coupling agent.

18. The electrostatic image developing toner of claim 17 wherein the coupling agent is an alkylalkoxysilane compound.

19. The electrostatic image developing toner of claim 18 wherein the alkylalkoxysilane compound is methyltrialkoxysilane, methyltriethoxysilane, ethyltriethoxysilane, hexyltrimethoxysilane, or octyltrimethoxysilane.

20. The electrostatic image developing toner of claim 17 wherein an amount of the coupling agent is 0.01-10 parts by weight based on the total weight of the total weight of titanic acid compound.

21. The electrostatic image developing toner of claim 20 wherein an amount of the coupling agent is 0.5-5 parts by weight based on the total weight of the total weight of titanic acid compound.
